(19) United States
(12) Patent Application Publication
(10) Pub. No.: US 2008/0123637 A1
(43) Pub. Date: May 29, 2008

(54) Multiplexing system for controlling loads in boats or mobile homes

(75) Inventor: Fred Zolls, Schwarzenbruck (DE)

Correspondence Address: LERNER GREENBERG STEMER LLP, P O BOX 2480, HOLLYWOOD, FL, 33022-2480, US

(73) Assignee: Ellenberger & Poensgen GmbH, Altdorf (DE)

(21) Appl. No.: 11/949,410

(22) Filed: Dec. 3, 2007

Related U.S. Application Data
(63) Continuation of application No. PCT/EP2006/001751, filed on Feb. 25, 2006.

(30) Foreign Application Priority Data
Jun. 3, 2005 (DE) DE102005025573.6

(51) Int. Cl. H04L 12/50; H04Q 11/00

(52) U.S. Cl. 370/362

(57) ABSTRACT

A multiplexing system for use in a boat or recreation vehicle is used to switch an electric load. The system contains at least two bus devices that are connected via a bus line, whereby each one contains a number of inputs and/or load outputs. Each input can be connected to the signal emitter to guide an input signal, during which each load output, which is used to output an output voltage, can be connected to an electric load circuit and a switch element that is used to switch the output voltage. The system includes a control device used to control each load output according to the input signal that is disposed on an associated input, which can be configured such that each input can be allocated to any particular load output by logical interlinking. The control device is formed from a plurality of hardware-sided identical base modules.

### CROSS-REFERENCE TO RELATED APPLICATIONS

This is a continuing application, under 35 U.S.C. § 120, of copending international application No. PCT/EP2006/001751, filed Feb. 25, 2006, which designated the United States; this application also claims the priority, under 35 U.S.C. § 119, of German patent application No. 10 2005 025 573.6, filed Jun. 3, 2005; the prior applications are herewith incorporated by reference in their entirety.

### BACKGROUND OF THE INVENTION

### Field of the Invention

The invention relates to a multiplexing system for switching electrical loads, particularly for use in a boat or a mobile home. The system has at least two bus devices for data transfer, which are connected by a bus line, of which each has a number of inputs and/or a number of load outputs. Each input can be connected for the delivery of an input signal from a signal transmitter, and each load output can be connected, to output an output voltage, to an electrical load circuit, and contains a switch element for switching the output voltage. A control device controls each load output according to the input signal applied to an associated input. The control device is configurable so that any load output can be assigned to each input by a logical connection.

In general, a multiplexing system is defined as an electrical installation system that allows the switching of a multitude of electrical load circuits via a common control channel. The term “switching” in a more narrow sense refers to the control by which the load circuit can be set in a binary way between an “off” state and an “on” state, but, in a broader sense, it also refers to a control where the load circuit can be controlled continuously to be turned on or off, or in several steps between a minimum state and a maximum state.

Multiplexing systems of the above-mentioned type are already used in many applications in the commercial vehicle sector. Such multiplexing systems are based particularly frequently on the so-called CAN bus technology, as defined particularly by the standard SAE J1939 as well—for use in the marine sector—by the standard NMEA 2000.

A multiplexing system configured for the marine application sector, particularly for sport or leisure boats, must satisfy special requirements. Such a system must be particularly robust and fail-safe in view of the relatively rough conditions of use at sea or on continental waters. In addition, if damage occurs nevertheless, such a system should be easy to repair, particularly with on-board measures, and/or it should guarantee at least manual emergency operation. Moreover, such a system must be of compact construction and flexible to adapt, so that it can be used for a multitude of different functions in the typically restricted spaces of sport or leisure boats. At the same time, the system should be relatively inexpensive to produce and thus it should lend itself to being manufactured cost effectively.

A multiplexing system that is intended for use in a mobile home, particularly a camper or a house trailer, is also subject to corresponding requirements.

A multiplexing system is known from published, European patent application EP 0 754 599 A1, corresponding to U.S. Pat. No. 5,859,845. In the known multiplexing system, a control signal, which is generated as the result of an actuation of a switch of a control panel is bundled by a multiplex unit and sent to a multiplex transmission line. Load control units receive the bundled control system and guide the electrical load applied to a corresponding load as a function of the received control signal. Control data that reflect a type of output control assigned to the corresponding load are stored in relation to the switch. The multiplexing system contains a control device that controls the electrical power applied to the corresponding load using the control data.

From U.S patent publication No. 2003/0033067 A1, a control system for controlling multiple functions in a motor vehicle is known, for example, gasoline injection, anti-blocking system, airbag control, and hydraulic control. The system contains several electronic control units, for carrying out these functions, which are connected via a bus line.

Published, French patent application FR 2 859 683 A1 discloses a control system for controlling electrical loads in a vehicle. In the context of this system, several signal transmitters and several load outputs are provided, where the signal transmitters and the load outputs can be assigned to each other by programmable control measures.

From published, European patent EP 0 751 046 A1, corresponding to U.S. Pat. No. 5,845,221, a control system for controlling electrical loads in a vehicle with a number of load outlets is known. Here each load output functions as an overcurrent protection, by automatically switching off a load that is connected to it, in the case of a short circuit in the load.

From published, non-prosecuted German patent application DE 42 39 762 A1 a safety device for a motor vehicle is known, which prevents an unauthorized person from starting the motor vehicle, or makes it difficult to do so. The safety device contains a bi-stable relay with a series connected plug-in position for a fuse. The relay and the plug-in position can be bridged by a bypass line, in which a second plug-in position for a fuse, so that the relay can be bridged by replugging the fuse.

From the English abstract of Japanese patent application JP 09306269 A, a switch circuit for generating a switch signal is known, where, when a switch is closed, a current pulse for cleaning corroded switch contacts is generated.

### BRIEF SUMMARY OF THE INVENTION

It is accordingly an object of the invention to provide a multiplexing system for controlling loads in boats or mobile homes that overcomes the above-mentioned disadvantages of the prior art devices of this general type.

With the foregoing and other objects in view there is provided, in accordance with the invention, a multiplexing system for switching electrical loads. The multiplexing system contains a bus line and at least two bus devices for data transfer and connected by the bus line. The bus devices each includes a number of inputs each connected for delivering an input signal from a signal transmitter, and a number of load outputs each connected to output an output voltage to an electrical load circuit. Each of the load outputs has a switch element for switching the output voltage. A control device is provided for controlling the load outputs according to the input signal applied to an associated one of the inputs. The control device is configured so that any of the load outputs can be assigned to the inputs by a logical connection. The control device has a number of base modules having identical hardware, where in each case one of the base modules is connected to each of the bus devices.

Accordingly, the multiplexing system (hereafter called system for short) contains at least two bus devices, which are connected to each other via a bus line for mutual data exchange, and where each device has a number of inputs and/or a number of load outputs. Each input can here be connected, to apply an input signal, from/to a signal transmitter, particularly a mechanical push button or switch, whereas each load output delivers a switchable output voltage for an electrical load circuit to be connected. The system furthermore includes a control device to assign the inputs to corresponding load outputs, where the control device can be configured so that any load output can be assigned by a logical connection to the or each input, so that the load output is switched by the input signal applied to the associated input. The control device is formed, according to the invention, from a number of base modules that are of identical construction in terms of their hardware, of which in each case one is assigned to each bus device, particularly forming a component of the bus device.

The above-described system makes it possible to produce a particularly flexible and adaptable installation for the greatest variety of switching functions while at the same time being of simple construction. The simplification is achieved here primarily by the modular construction of the system, which is reflected particularly in the use of the same base module for each bus device.

Each base module contains, in an advantageous embodiment, a configuration memory, in which a configuration assigned to the bus device is stored.

A “configuration” denotes a collection of configuration data, which contains particularly logical connections of the above-mentioned type. The configuration assigned to each bus device can be established and changed by the user. This process of the establishment or change of a configuration is called “configuring” below.

By the distribution of the configuration data over the base modules installed in each bus device, a decentralized system control is created, where all the bus devices communicate with each other substantially with the same authority as “master.” The decentralized configuration of the control device—particularly in comparison to a central “master-slave” control concept—is particularly fail-safe. In particular, at least a limited functionality of the system remains guaranteed even if one bus device fails.

A particularly simple and flexible control logic is achieved by storing the logical connections based on an output, i.e., the logical connection assigned to a certain input of a certain load output is always stored in the configuration of the bus device to which the load output is assigned. In other words, each input, or the associated bus device, transmits the corresponding input “blindly” to the bus line. The evaluation and assignment of the input signal is carried out only by the bus device to which the corresponding load output belongs. As a result of the output-based signal processing, particularly high flexibility and simultaneously a simple configuration procedure is achieved.

To be able to produce complex circuits, it is preferred to allow for the possibility of assigning several inputs to the same load output. Conversely, several load outputs can also be assigned to the same input. The latter possibility is ensured particularly already by the purely output-based management of the logical connections.

In an advantageous embodiment, moreover, a configurable switch rule is assigned to each input, and used to define the switching behavior of the input, and thus also determine the effect of the input signal applied to the input, and/or the change of the input signal, on the state of the assigned load output. In other words, the switch rule establishes virtually a “switch type,” for example, push button, toggle, alternating switch, etc., for the input, which consequently results in a given logical processing of the input signal. It is preferred, in the process of configuring the system to offer a list of available switch rules or “switch types” for an input to be configured. Examples of such switch rules are described in greater detail below.

The switch rule which is assigned to an input is stored, again preferably output-based, i.e., within the configuration of the bus device to which the load output linked with this input belongs. The output-based storage of switch rules again serves the function of simplifying the control logics. In particular, in the process of configuring, it allows assigning in each case a differentiated selection of suitable switch rules to different load output types, thus ensuring that only those switch rules are assigned to an input, which are also suitable for the linked load output.

The bus devices and the bus line connecting them form advantageously a CAN bus system, particularly according to the relevant standards SAE J1939 and/or NMEA 2000. The communication between the bus devices here occurs advantageously via the corresponding assigned base modules, each of which presents a CAN bus interface for this purpose.

To be able to produce particularly simple bus devices, each base module, in a preferred embodiment, presents a parallel interface, whose individual ports make it possible to directly address inputs and/or load outputs. The base module contains advantageously also one or more series interfaces. The latter are used particularly for communication with optionally present additional function modules of the same bus device. Such a function module can, as desired, control additional inputs or outputs of the bus device, or another system-internal function, for example, current measurement, overload detection or wire break detection. However, such a function module can also be used as a control unit for a system-external function, for example, it can work in collaboration with sensors, such as brightness or motion detectors, it can control a display or a monitor, or it may be configured for communication with a remote control or a telecommunication or data network, etc.

To configure the system and for a simplified function or error analysis, at least one bus device contains a USB interface, which can be used to connect a computer, particularly a PC, which is provided with configuration software.

A particularly simple installation and repair of the system is achieved using a preferably provided backup formalism. In the context of the backup formalism, each bus device (reference device) is assigned an additional bus device as partner device. As a result of this assignment, a backup copy of the configuration of the reference device is stored in the partner device. The partner device thus controls the configuration of the reference device, it automatically detects a loss of configuration (for example, as a result of the replacement of the reference device), and, in that case, it restores the configuration of the reference device with the help of the backup copy. In this way it is possible to simply replace each one of the bus devices without affecting the functional capacity of the system or requiring a new configuration. It is advantageous for the assignment of reference devices and partner devices to be freely selectable during the process of configuration.

In a preferred embodiment, an electronic overload cutoff, which can be configured with regard to the overload threshold value that triggers the cutoff process, is assigned to at least one load output. A threshold value generator to provide this overload threshold value is formed advantageously from an electronically configurable component, which retains the overload threshold value in a nonvolatile manner, so that the overload cutoff remains functionally capable even in the case of a possible failure of the control electronics of the bus device. In particular, a passive, electronically trimmable resistance is provided as threshold value generator. An electrical component is called “passive” if it functions in accordance with its intended purpose, without having its own power supply. Such a resistance is manufactured, for example, by the company Microbridge Technologies Inc. under the name of “rejuster.”

Alternatively or additionally it is advantageous to protect at least one load output by use of a flat fuse or a protective switch compatible therewith. Such a load output accordingly has a plug-in position for a flat fuse or a protective switch, which is series connected with the switch element of the load output. To ensure, in case of a failure of the system electronics, a manual emergency operation, at least one load output additionally or alternatively presents an auxiliary position for a flat fuse or a protective switch compatible therewith, which is connected parallel to the switch element of the load output, so that the switch element, by plugging in the flat fuse or the protective switch in the auxiliary plug-in position can be bridged. In the last case, the load circuit that is connected to the load output is switched simply by inserting or pulling out the flat fuse or the protective switch. Such an auxiliary plug-in position is assigned particularly to load outputs that are provided for connecting a safety-relevant load circuit, for example, to power the position lamps of a boat.

For a simple monitoring of the function of the system, and optionally a simplified error diagnosis, a preferred embodiment of the invention furthermore is configured so that each load output transmits a status signal back to the base module. The status signal here characterizes particularly the switch condition of the switch element assigned to the load output. In addition or alternatively, the status signal contains information regarding error states of the load circuit connected to the load output, particularly a wire break and/or an overload or a short circuit. To establish such an error status, the load output contains in this embodiment a load circuit monitoring circuit. The latter is configured particularly to detect an error state independently of the switch state of the load output.

To prevent a signal transmitter, which is connected on the input side to the system, from causing a switching error (or, particularly, from failing) as a result of oxide formation on the switch contacts, it is advantageous to assign a contact cleaning circuit to at least one input. The contact cleaning circuit is configured so that when the signal transmitter that is connected to the input is actuated, a current pulse is issued to the signal transmitter, which destroys any oxide layer on the switch contacts. The contact cleaning circuit is configured particularly as a capacitor circuit.

In addition to the inputs and the load outputs, the system contains, in a preferred embodiment, a number of control outputs. One or more such control outputs are here assigned in a fixed way to an input, or they can at least be assigned by configuring the system. The control outputs serve for controlling control lamps, to be able to visualize the switch processes connected with an input, for control purposes. A control signal that can be detected at such a control output is here linked unequivocally with the status signal of the load output that is assigned to the input that belongs to the control output.

To be able to adapt the light intensity of the control lamps, which can be connected to each control output, to the lighting conditions in a room, and/or to be able to adapt the energy consumption of such control lamps if needed, it is advantageous to assign to each control output a dimmer circuit, by which the strength of the control signal can be controlled continuously or in steps. The control signal is preferably a direct current signal. As “intensity” of the control signal, the voltage amplitude of the control signal is here controlled by the dimmer circuit. The dimmer circuit is preferably controllable together with a central signal transmitter for all control outputs.

Other features which are considered as characteristic for the invention are set forth in the appended claims.

Although the invention is illustrated and described herein as embodied in a multiplexing system for controlling loads in boats or mobile homes, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic simplified block diagram of a multiplexing system for switching electrical loads, which contains, as bus devices, two panel modules for connection to a switch panel, three power modules for the control of electrical load circuits, as well as a CAN bus connecting these bus devices according to the invention;

FIG. 2 is a simplified block diagram of an input of the bus device according to FIG. 1;

FIG. 3 is a block diagram according to FIG. 2 of a control output of the bus device according to FIG. 1;

FIG. 4 is a block diagram according to FIG. 2 of a load output of the bus device according to FIG. 1; and

FIG. 5 is a schematic simplified block diagram of a base module that forms a component of each bus device according to FIG. 1.

### DETAILED DESCRIPTION OF THE INVENTION

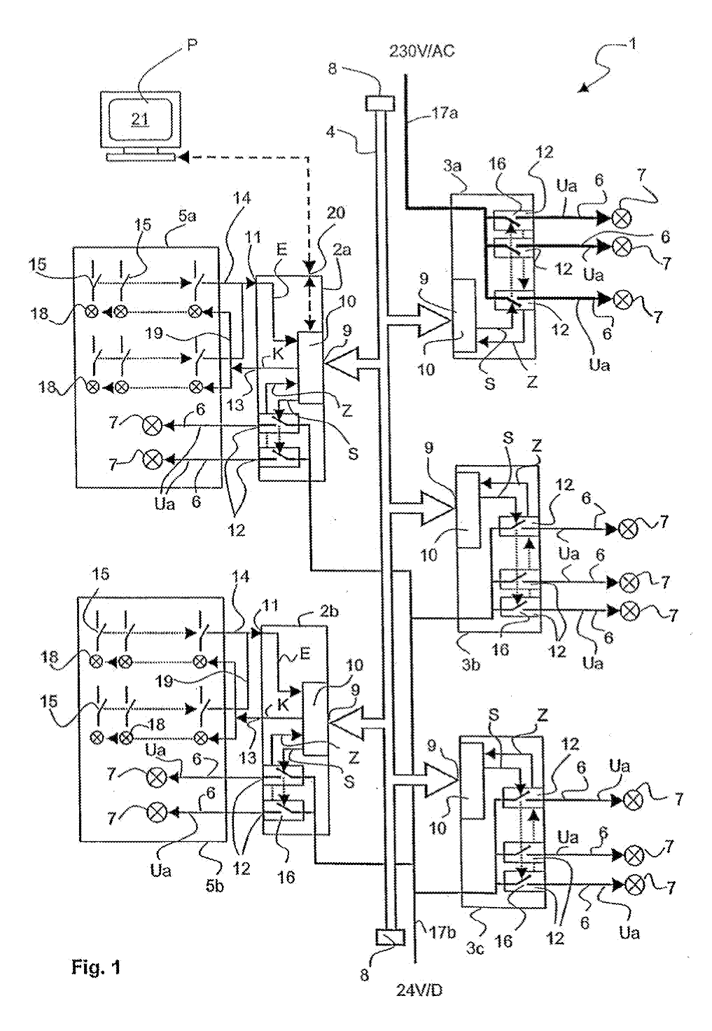

The same reference numerals are always used in all the figures for parts and magnitudes that correspond to each other. Referring now to the figures of the drawing in detail and first, particularly, to FIG. 1 thereof, there is shown schematically and in a simplified illustration a multiplex system 1 (hereafter called system 1 for short) for switching electrical loads, which is intended particularly for use in a sport or leisure boat or a mobile home (house trailer, house mobile, etc.).

The system 1 contains, for example, five bus devices, including a first panel module 2a, a second panel module 2b, as well as three power modules 3a, 3b, 3c. Moreover, the system 1 contains a bus line 4 for connecting the bus devices. The panel modules 2a, 2b each serve to connect an associated switch panel 5a, 5b of the boat or mobile home. Each power module 3a, 3b, 3c serves to provide an electrical supply for a number of electrical load circuits 6, in which in each case one or more peripheral devices 7, i.e., electricity consuming devices, such as, position lights, interior room lighting, household devices, etc., or plugs, are connected.

Each bus device (i.e., panel module 2a, 2b or power module 3a, 3b, 3c) exchanges data with every other bus device via the bus line 4. The data exchange is here based on the so-called CAN bus technology, as defined particularly by the pertinent standards SAE J1939 and NMEA 2000. The bus line 4, according to this technology, is constructed as a shielded, twisted double-pole line that is closed off at both end points with 120Ω terminating resistors 8. Each panel module 2a, 2b or power module 3a, 3b, 3c is connected via a CAN bus interface 9 to the bus line 4. The CAN bus interface 9 is integrated in a base module 10, which is a component of each bus device.

For communication with the connected switch panel 5a, 5b, or load circuit 6, each bus device (i.e., panel module 2a, 2b and power module 3a, 3b, 3c) has a number of inputs 11, load outputs 12 and/or control outputs 13.

Each input 11 serves for inputting an input signal E, corresponding to a switch state, into the system 1. For the generation of the input signal E, the input 11 is connected in the mounted state via a signal line 14 to a signal transmitter 15, for example, in the form of a mechanical push button or switch. A number of such signal transmitters 15 are provided particularly in the frame of each switch panel 5a, 5b. Each panel module 2a, 2b is provided accordingly with a sufficiently large number of inputs 11 to be able to contact the signal transmitter 15 of a conventional switch panel 5a, 5b of medium size. In preferred dimensions, approximately thirty inputs per panel module 2a, 2b are provided. For connecting additional, separate signal transmitters, for example, light switches, the power modules 3a, 3b, 3c can also be provided with a number of inputs 11 (not shown explicitly).

The load outputs 12 serve to deliver an output voltage Ua in the load circuit 6, which is connected to the load output 12, where, for switching the output voltage Ua, each load output 12 is provided with a switch element 16. The load outputs 12 are provided as a component of the power modules 3a, 3b, 3c. To supply the switch panels 5a, 5b as well as the load circuits 6, which are disposed in their vicinity, each panel module 2a, 2b is also provided with several, particularly two, load outputs 12.

To supply the load outputs 12, each panel module 2a, 2b or power module 3a, 3b, 3c is connected to a power supply grid 17a, 17b of the boat or mobile home. The power module 3a is here configured to deliver an output voltage Ua of 230 volts alternating current (230 V/AC), and it is connected to the power supply grid 17a corresponding to this voltage type. The power modules 3b, 3c as well as the load outputs 12 of the panel modules 2a, 2b, on the other hand, are provided to deliver a 24 volt direct current (24 V/DC), and they are connected to the corresponding 24-volt supply grid 17b. The load outputs 12 of the different power modules 3a, 3b and 3c are preferably configured for different output loads (for example, 5 A, 10 A or 20 A maximum load).

The switch element 16 of each load output 12 of each bus device is switched by a control signal S. Each load output 12 transmits a status signal Z, which contains data on the switch state of the load output 12, back to the base module 10.

The control outputs 13 serve for controlling control lamps 18, which are again provided primarily in the frame of the switch panels 5a, 5b. In the exemplary installation according to FIG. 1, a control lamp 18 is assigned to each signal transmitter 15 of each switch panel 5a, 5b, to display a switch state corresponding to the signal transmitter 15, or an error state. For controlling the control lamps 18, each panel module 2a, 2b has a number of control outputs 13, which corresponds to the number of inputs 11, where each control output is wired through a control line 19 to deliver a control signal K to the associated control lamp 18.

The panel module 2a is provided additionally with a USB (Universal Serial Bus) interface 20, through which a control computer 21 can be connected to the multiplexing system 1. The control computer 21 is provided particularly with configuration software P, by which the system 1 can be configured in a manner described in greater detail below. In the control computer 21, it is also preferred to provide for the implementation of applications for the functional analysis of the system configuration, or for error diagnosis. Optionally, a virtual representation of a switch panel 5a or 5b is also implemented in the control computer 21, which can at least partially replace the physical switch panel 5a, 5b.

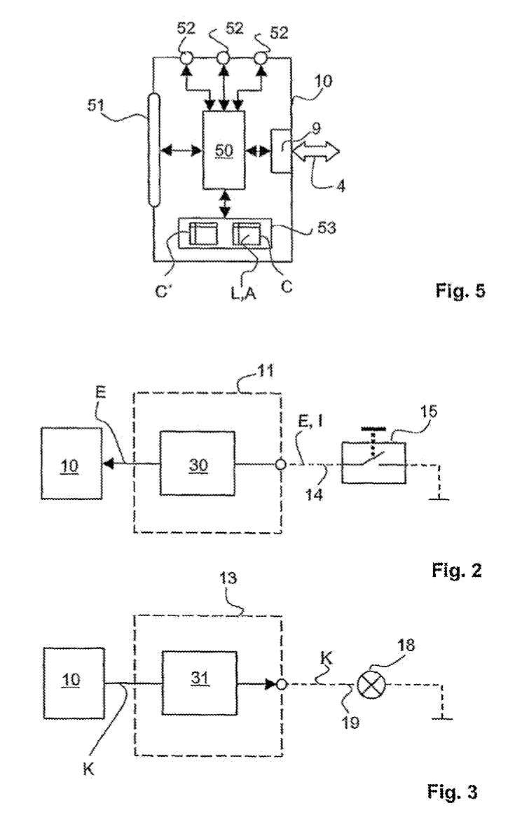

To prevent functional disturbances caused by oxidation of the switch contacts of the signal transmitter 15, a contact cleaning circuit 30 is associated with each input 11—as indicated in FIG. 2 with a simplified block diagram of an input 11. The contact cleaning circuit 30 is configured so that, when the signal transmitter 15 is actuated, particularly by draining a capacitor, a current flow I is to be delivered to the signal transmitter 15, to destroy any oxide layer present.

To each control output 13—as shown in FIG. 3-a dimmer circuit 31 is assigned, by which the amplitude of the control signal K, and thus the brightness of the control lamp 18 subject to control, can be regulated in steps. The dimmer circuits 31 of all the control outputs 13 can preferably be controlled together by a central regulator of a switch panel 5a or 5b, to be able to adapt the brightness of the control lamps 18 to the lighting conditions in the room and the personal preference of a user. Alternatively, the dimmer circuits 31 can also be controlled by a daylight sensor, or they can be switched while being coupled to position or flood lights of the boat or mobile home.

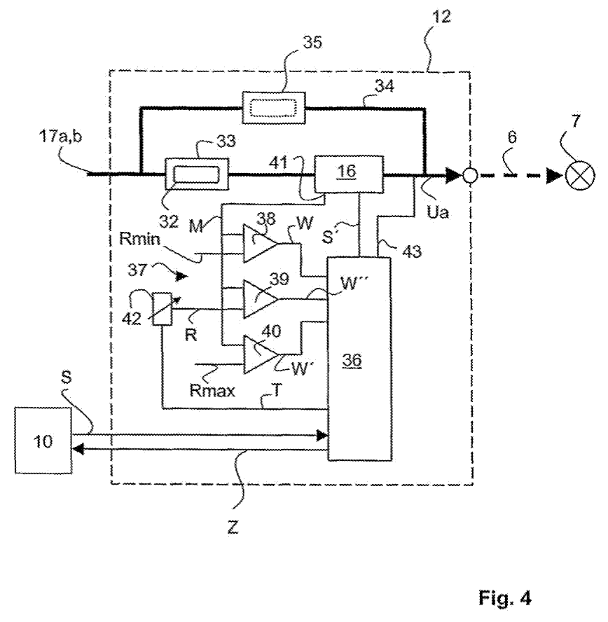

A core component of the load output 12 shown in greater detail in FIG. 4 is the switch element 16, which can be an electrical power switch, particularly a so-called PROFET, and which is connected between the power supply grid 17a and 17b, respectively, and the load circuit 6, to connect the load circuit 6. The switch element 16 is here protected by a flat fuse or a protective switch 32 compatible therewith against overload. The protective switch 32 is plugged in a detachable way at a plug-in position 33, which is connected directly before the switch element 16. The plug-in position 33 and the switch element 16 are bridged by a bypass 34, in which, during normal operation, an unoccupied auxiliary plug-in position 35 is arranged, in which the protective switch 32 or a flat fuse can be inserted alternatively. The bypass 34 is thus interrupted during normal operation, but it allows an emergency operation of the load output 12 by (for example, in the case of the failure of a switch element 16) allowing the possibility for manually switching the load output 12 by replugging the protective switch 32 from the plug-in position 33 manually into the auxiliary plug-in position 35.

For the control of the switch element 16, the load output 12 contains control logics 36, to which the control signal S from the base module 10 is applied. During normal operation, the control logics 36 control the switch element 16, switching it on or of, by delivering a control signal S′ which corresponds to the control signal S. In a deviation therefrom, the control logics 36 switch the load output 12 off, if an error state is detected by an associated load circuit monitoring circuit 37. The load circuit monitoring circuit 37 is configured to detect an overload or short circuit, as well as a line break as an error state. The load circuit monitoring circuit 37 contains, for this purpose, three comparators 38, 39 and 40, to whose measurement input a measurement signal M is applied, which is proportional to the current flowing through the switch element 16. The measurement signal M is delivered through a current mirror output 41 of the switch element 16. The switch element 16 here functions simultaneously as a current measuring device.

By the application of a minimal threshold voltage Rmin to the reference input of the comparator 38, the latter is configured to detect a line break, i.e., an electrically interrupted load circuit 6. In the case of a line break, the current flow through the switch element 16 stops, resulting in the current-proportional measurement value M falling below the minimal threshold voltage Rmin, and the comparator 38 responds. The output voltage of the comparator 38 is applied as a warning signal W to the control logics 36.

A maximum threshold voltage Rmax is applied to the reference input of the comparator 40. As a result, the comparator 40 detects a short circuit inside the load circuit 6, because, in this case, the current flow through the switch element 16 diverges and exceeds as a result the measurement signal M of the maximum threshold voltage Rmax. The output voltage of the comparator 40, which switches under these circumstances, is applied as a warning signal W′ to the control logics 36.

The third comparator 39 functions as an electronic overload detection, by applying an adjustable voltage as overload threshold value R to the reference input of the comparator 39. The comparator 39 responds if the measurement signal M exceeds the overload threshold value R as a result of a current increase in the load circuit 6. The output voltage of the comparator 39 is applied as a warning signal W″ of the control logics 36.

As threshold value generator that generates the overload threshold value R, a passive electronic trimmable resistance 42 is provided. The resistance 42 is trimmed by a trimming signal T generated by the control logics 36 (or directly by the base module 10), i.e., it is set with respect to its resistance parameter. As a passive component, i.e. a component that is independent of the power supply, the resistance 42 maintains its resistance parameter automatically after the setting, resulting in the overload threshold value R being generated even if the trimming signal T is not available in case of a failure of the electronics.

To be able to detect an error state within the load circuit 6, particularly a line break, even if the load output 12 is switched off (i.e., the switch element 16 is locked by control), the control logics 36 continue to be connected via a test line 43 directly with the load circuit connection of the load output 12.

The status signal Z that is returned by the control logics 36 to the base module 10, in the failure case, contains, in addition to the current switch state of the switch element 16 (ON/OFF), an error message which is differentiated as a function of the error type (short circuit, overload, wire break).

The base modules 10, which are assigned to the panel modules 2a, 2b or power modules 3a, 3b, 3c, have identical structures as far as hardware technology is concerned. The core of each base module 10—as represented in greater detail in FIG. 5—is formed by a controller 50. The controller 50 accesses the CAN bus interface 9 for the data exchange with the base modules 10 of the other bus devices. Each base module 10 is, moreover, provided with a parallel interface 51 (particularly one containing twenty ports), and with a number of (particularly three) serial interfaces 52. The ports of the parallel interfaces 51 are provided primarily to respond directly to individual inputs 11, load outputs 12, or control outputs 13. Using the parallel interface 51, it is thus particularly simple, and consequently cost effective, to configure bus devices. The serial interfaces 52 are intended primarily for communication with other, separately controller-controlled function modules of the same bus device (not shown in detail). Such function modules can respond, for example, to other inputs 11, load outputs 12 or control outputs 13, or they can take over separate data transfer, monitoring or display functions. Such a function module controls, for example, a sensor (particularly a motion sensor, temperature sensor, etc.), and it fulfils the function of a motion detector, an alarm installation, etc. Another example of such a functional module is a data transfer module, which is configured for communication with a remote control or a mobile radio network, etc., and thus allows the remote control of the system 1 and/or the sending of messages through the system 1. Again either additionally or alternatively, a function module can be provided to control a display.

Each base module 10, finally, contains a configuration memory 53, in which a configuration C of the bus device (i.e., of the panel module 2a, 2b, or the power module 3a, 3b, 3c), which belongs to the base module 10, is stored.

As a result of the configurations C of the bus devices, the inputs 11 of the system 1 of the admissible load outputs 12 are disposed so that, as a result of an input signal E applied to a certain input 11, or its change, a certain switch state of the associated load output 12 can be caused. The assignment occurs by a number of logical connections L, which in each case link one or more inputs 11 with a load output 12. The logical connections L are stored based on output, i.e., namely in the configuration C of the panel module 2a, 2b or power module 3a, 3b, 3c of which the corresponding load output 12 is a component. During the process of configuring the system 1, each input 11 can be assigned to any load output 12 of any bus device.

The configuration C of a bus device contains, furthermore, a number of switch rules A, by which the value of the input signal E applied to an input 11 and/or its change can be correlated with the switch state of the corresponding load output 12 (or with the controlled signal applied to this load output 12). Each switch rule A is assigned to an input 11 and it defines a “switch type” for the input 11. The switch rule A is preferably stored based on output, i.e., contained in the configuration C of the bus device of which the load output 12 linked with the input 11 is a component. A switch rule A contains, furthermore, a preferably fixed predetermined base state (or default state), which establishes the switch state of the associated load output 12 immediately after the activation of the system 1.

In the definition of a switch rule A, the “switch type” assigned to an input 11 can in principle be defined as a “push button” or “switch.” In the case of an input 11 defined as a “push button,” a pulse-like, i.e. two-fold, change of the input signal E (for example, OFF→ON→OFF) is evaluated as a switch command. In the case of an input 11 defined as a “switch,” a simple change of the input signal E (OFF→ON or ON →OFF) is evaluated as a switch command.

For a more detailed determination of the switch rule A, the following options are provided as a selection:

“Toggle”: Several inputs 11 linked to a common load output 12 as “toggle” deliver a control signal S, which changes state with each pulse-like change of any associated input signal E. The “toggle” logical connection of N inputs 11 with the same load output 12 linked is equivalent to defining each one of the inputs 11 as a “push button.” In the base state, the load output 12 which is linked to the “toggle” inputs 11 is “OFF.” After the activation of the system 1, the load output 12 is thus first switched off in each case.

“Alternating switch”: Several inputs 11 linked to a common load output 12 as “alternating switch” deliver a control signal S which changes state with each change of any associated input signal E. This type of logical connection is equivalent to the definition of all the inputs 11 as a “switch.” A load output 12 linked with “alternating switch” inputs 11 is “OFF” in the base state.

“On/off switch”: If only a single input 11 defined as “switch” is linked to a load output 12, then the control S follows the state of the input signal E. As desired, the “On/off switch” can be operated as an “opener” or a “closer,” where the input signal E and the control signal S are correlated in opposite direction in the first case, and in the same direction in the last case.

The input 11 can also be defined particularly as “switch” (“alternating switch” or “on/off switch”) if it is in fact connected in the physical installation with a signal transmitter 15 configured as a push button. Such a linked input 11 acts as a “momentary switch,” thus it activates or deactivates the associated load output 12 only if, and for as long as, the associated signal transmitter 15 is actuated. This type of logical connection is particularly advantageous for controlling a horn or a door opener.

“Activate push button,” “deactivate push button”: Here an input 11, as “activate push button” and, in the regular case, another input 11 as “deactivator push button” are linked to the same load output 12. The associated control signal S is activated in the case of a pulse-like change of the input signal E associated with the first mentioned input 11 and it remains activated until a pulse-like change of the input signal E applied to the last mentioned input 11 occurs.

“Main switch”: An input 11 defined as “main switch” writes over all the other inputs 11 linked to the same load output 12. Here the logical connection is preferably not a logical AND connection. Rather, each load output 12 linked to the “main switch” input 11 is set to the base state assigned in each case when the “main switch” is switched on again. For example, if a load output 12, which otherwise is operated only via “alternating switch” or via “toggle,” is switched off by a “main switch,” then it remains first switched off after the “main switch” is switched on again, until it is activated again by another logical connection. A load output 12, which is linked to an “on/off switch,” on the other hand, follows the state of the “on/off switch” after the “main switch” is switched on again.

“Locking”: An input 11 defined as “locking” necessarily switches the associated load output 12 off in case of activation, so that the load output 12 cannot be activated by another assigned input 11.

Instead of a physical input 11, a virtual input can also be connected with a load output 12. Such a virtual input can be addressed, for example, by a remote control. Furthermore, a load output 12 can also be linked with a virtual “always on” or “always off” input. A load output 12 that is linked in this way is accordingly always switched on or switched off. This logical connection can only be overwritten by an input 11 defined as “main switch.”

A configurable time function is assigned preferably to each load output 12 or at least to some of the load outputs 12. The time function acts, as desired, as a delay circuit, by the fact that a switch command generated by a change of an input signal E is transmitted further only after a configurable delay time to the switch element 16 of the load output 12. The delay circuit can act, as desired, unidirectionally, i.e., only in the case of a switch on command, or only in the case of a switch off command, or bidirectionally, i.e., during switching on and switching off. In another option, the time function acts as a “staircase circuit,” by automatically retracting a change in a switch state of the associated load output 12 after a configurable delay time, particularly by automatically switching the load output 12 off again.

Each control output 13 is preferably assigned in a fixed way to an input 11. The control signal K applied to this control output 13 is then determined by the status signal Z, which the load output 12 linked to this input 11 delivers. In other words, the control signal K of a control output 13 always reflects the actual switch and error state of the load output 12 which is operated by the associated input 11. In the case of the control of a two-color LED as control lamp 18, the control signal K, for example, is coded in such a way that when the load output 12 is switched on, the LED emits green light, and when the load output 12 is switched off, the LED is switched off, and, if a line break has been detected, the LED blinks emitting green light, and, if an overload is detected, the LED emits red light or blinks emitting red light.

To allow a simple exchange of any bus devices, a partner device is assigned to each panel module 2a, 2b and power module 3a, 3b, 3c. In the configuration memory 53 of the base device 10 of this partner device, a backup copy C′ of the configuration C of the first mentioned bus device (reference device) is stored. The partner device is configured to monitor the reference device, and, in case of the detection of a configuration loss, to automatically reestablish the configuration C of the reference device on the basis of a backup copy C′. The assignment of a partner device to a panel module 2a, 2b or a power module 3a, 3b, 3c is freely selectable in configuring the system 1. In this way, any bus device can be replaced without having to newly configure the system 1 as a result.

The bus devices and the bus modules 10 arranged in the latter are constructed with protection from humidity for marine use, in particular, the base modules 10 are configured in protection class IP00, and the bus device in protection class IP54.

1. A multiplexing system for switching electrical loads, the multiplexing system comprising:
a bus line;
at least two bus devices for data transfer and connected by said bus line, said bus devices each including:
a number of inputs each connected for delivering an input signal from a signal transmitter;
a number of load outputs each connected to output an output voltage to an electrical load circuit, and each containing a switch element for switching the output voltage; and
a control device for controlling said load outputs according to the input signal applied to an associated one of said inputs, said control device configured so that any of said load outputs can be assigned to said inputs by a logical connection, said control device having a number of base modules having identical hardware, where in each case one of said base modules is connected to each of said bus devices.

2. The system according to claim 1, wherein each of said base modules contains a configuration memory for storing a configuration assigned to an associated bus device of said bus devices.

3. The system according to claim 2, wherein said configuration assigned to said associated bus device contains logical connections based on said load outputs associated with said associated bus device.

4. The system according to claim 1, wherein several of said inputs can be assigned to a same one of said load outputs.

5. The system according to claim 2, wherein said base modules each have a configurable switch rule assigned to each of said inputs, by said configurable switch rule, according to the input signal received and/or of a change of the input signal, a control signal is determined which is to be delivered to an associated load output of said load outputs.

6. The system according to claim 5, wherein said switch rule assigned to one of said inputs in each case is stored within said configuration for said associated bus device having said load output assigned to said one input.

7. The system according to claim 1, wherein said bus devices and said bus line form a CAN bus system.

8. The system according to claim 7, wherein each of said base modules has a CAN bus interface.

9. The system according to claim 1, wherein each of said base modules contains a parallel interface for communicating with at least one of said inputs and said load outputs of an associated bus device of said bus devices.

10. The system according to claim 1, wherein at least one of said bus devices has an electronic function module to carry out one of a data transfer function, a monitoring function and a display function.

11. The system according to claim 10, wherein said base modules each contain at least one serial interface.

12. The system according to claim 1, wherein at least one of said inputs has a contact cleaning circuit configured for cleaning switch contacts of the signal transmitter by an application of a current pulse during a switch process.

13. The system according to claim 1, wherein at least one of said bus devices has a USB interface, through which a control computer, for configuring said bus devices with configuration software for configuring said bus devices, can be connected.

14. The system according to claim 1, wherein each of said bus devices, being a first mentioned bus device, is assigned another one of said bus devices functioning as partner device, said partner device containing and storing a device backup copy of the configuration of said first mentioned bus device, said partner device configured to automatically reestablish the configuration of said first mentioned bus device if said first mentioned bus device is replaced or in case of another loss of configuration, with a help of said device backup copy.

15. The system according to claim 1, wherein at least one of said load outputs has an electronic overload cutoff which can be configured with respect to a predetermined overload threshold value.

16. The system according to claim 15, wherein said at least one load output has a threshold value generator, said overload threshold value is preestablished in a non-transient way by an electronically configurable component being said threshold value generator.

17. The system according to claim 16, wherein said threshold value generator is a passive, electronically trimmable resistance.

18. The system according to claim 1, wherein at least one of said load outputs has a plug-in position series connected to said switch element, said plug-in position configured for receiving one of a flat fuse and a protective switch.

19. The system according to claim 18, wherein at least on of said load outputs has an auxiliary plug-in position configured for receiving one of a further flat fuse and a further protective switch, said auxiliary plug-in position being switched parallel to said switch element, so that said switch element can be electrically bridged by plugging the further flat fuse or the further protective switch in said auxiliary plug-in position.

20. The system according to claim 1, wherein each of said load outputs transmits back to at least one of said base modules a status signal characterizing a switch state of said switch element.

21. The system according to claim 1, wherein each of said load outputs contains a load circuit monitoring circuit for detecting an error state due to a line break and/or a short circuit in the load circuit connected to said load output, where a respective load output of said load outputs, if an error state is detected, delivers to one of said base modules a status signal characterizing the error state.

22. The system according to claim 20, wherein said two bus devices each have at least one control output assignable in a fixed way to at least one of said inputs, said control output outputting a control signal to be scanned for controlling a control lamp, where the control signal is determined by the status signal of said load output with which said one input is linked.

23. The system according to claim 22, wherein said control output has a dimmer circuit for controlling a strength of the control signal one of continuously and stepwise.

24. The system according to claim 21, wherein the system for switching the electrical loads is used in boats or mobile homes.

25. The system according to claim 10, wherein said electronic function module carriers out one of the data transfer function, the monitoring function and the display function for controlling one of a sensor, an emitter, a receiver, and a display.

26. The system according to claim 11, wherein said serial interface communicates with said electronic function module.
